(19) United States
(12) Patent Application Publication
(10) Pub. No.: US 2003/0102976 A1
(43) Pub. Date: Jun. 5, 2003

(54) ACTIVE FUEL CAP SENSOR USING MAGNETIC IMPULSE DETECTION

(76) Inventor: Mr. Roger Lavallee, Jamestown, RI (US)

(21) Appl. No.: 10/065,935

(22) Filed: Dec. 2, 2002

Related U.S. Application Data
(60) Provisional application No. 60/337,021, filed on Dec. 2, 2002.

(51) Int. Cl. G08B 21/00

(52) U.S. Cl. 340/687; 340/686.3; 340/547; 340/545.6

(57) ABSTRACT

### Abstract of Disclosure

An apparatus and circuit for monitoring the closed position of a fuel cap relative to a tank connection pipe . The fuel cap has a ratchet torque limiter for controlling the tightening of the fuel cap to the tank connection pipe. A magnet is connected to the fuel cap and a magnetic switch, such as a reed switch, is connected to the tank connection pipe or proximal thereto. The movement of the magnet relative to the magnetic switch, indicating a locked fuel cap condition, is sensed by an abrupt change in magnetic field strength of the magnet. When releasing members snap over the cams therein, a current pulse is induced in a pickup coil . This current pulse is sensed and a logic level high voltage is produced corresponding to a tightened fuel cap condition. A dashboard lamp is then extinguished indicated that the fuel cap is safely and securely tightened.

### Cross Reference to Related Applications

This application is related to and claims priority from earlier filed provisional patent application Serial No. 60/337,021, filed December 3, 2001.

### Background of Invention

The invention relates to an apparatus, assembly and method for monitoring the closed position of a locking fuel cap, with a magnet disposed in the locking fuel cap and a magnetic switch disposed at or proximal to a tank connection pipe.

There have been many attempts in the prior art to monitor the position of the locking fuel cap of a motor vehicle so that, when the locking fuel cap is not closed or closed incompletely, a warning signal appears on the dashboard of the vehicle.

For example, various prior art locking fuel caps have a bayonet catch and the magnet is disposed in such a manner, that it is in the vicinity of a reed switch when the bayonet catch is locked. Depending on the construction, the reed switch is thus either open or closed when the locking fuel cap reaches the locked position. Preferably, the reed switch is constructed so that it is closed in the locked position and that an associated evaluating circuit causes a warning signal to be displayed when the circuit of the reed switch is interrupted.

Since the magnetic field of the magnets cannot be localized to a narrow limited space, the position of the locking fuel cap can be determined only relatively inaccurately according to this principle. For many tank caps, the locking fuel cap is constructed as a screw-in plug. However, even in the case of bayonet-like tank caps, screw pitch surfaces are usually provided, which ensure that the plug, in the closed position, is pressed firmly against an associated seal. The possibility therefore exists that the locking fuel cap is not turned completely into the end position, in which the tank opening is sealed reliably and in which a subsequent loosening of the locking fuel cap due to vibrations is prevented because of the frictional engagement.

Magnetic switches have been known in the electronics industry for many years and are commonly used as sensors. Such magnetic switches include reed switches which are a magnetically activated devices that typically includes two flat contact tongues which are merged in a hermetically sealed glass tube filled with a protective gas fuel or vacuum. The switch is operated by an externally generated magnetic field, either from a coil or a permanent magnet. When the external magnetic field is enabled, the overlapping contact tongue ends attract each other and ultimately come into contact to close the switch. When the magnetic field is removed, the contact tongues demagnetize and spring back to return to their rest positions, thus opening the switch. The magnetic reed switch is then incorporated into a circuit environment for processing, such as for dashboard lamp control, and the like.

However, while desirable from a performance and cost standpoint, magnetic sensors do not perform reliably over wide temperature ranges, particularly at low temperatures. This is due primarily to the change in sensitivity of magnetic switches at different temperatures. Also, magnets, which are required for magnetic switch operation, get stronger as it gets colder. Magnets and magnetic sensors, such as reed switches, have negative temperature coefficients. Thus, the magnet becomes stronger as the temperature decreases while the switch becomes more sensitive. Under low temperature conditions, the magnetic switch prematurely operates to falsely indicate that the fuel cap has been tightly closed when it, in fact, has not. Therefore, the aforementioned fuel cap sensor assembly of the prior art is undesirable as it unreliably indicates a safe tightened fuel cap condition.

There have been attempts in the prior art to provide a fuel cap sensor assembly where a magnet is mounted to a spring-biased carriage of a torque limiter. In this prior art assembly, when the cap is screwed down, the magnet brings about the closing of the reed contacts of a magnetic switch, which is disposed on the outside of a tank connection pipe. In this manner, a signal is generated, which indicates the complete closing of the locking fuel cap. If the cap is turned further, releasing members slide from a cam in the torque limiter, and the magnet carrier, under the action of a spring, rebounds up once again, so that it assumes a resting position. In this resting position, the magnet is further removed from the switch. If the magnetic switch previously was closed, it remains closed because of the magnetic hysteresis in the closed state.

When the locking fuel cap is screwed out of the tank connection pipe, the distance between the magnet and the magnetic switch becomes larger, so that the magnetic switch opens up. Since the torque limiter can act only in one direction of rotation, a torque can not be transferred to the screw-in plug as it is being screwed out.

Subsequently, if the locking fuel cap is screwed back once again onto the tank connection pipe, the magnetic switch remains open, since the force of the magnet alone is insufficient for bringing the reed contacts into the closed position. Only when the limiting torque is exceeded once again and, at the same time, the magnet carrier is moved even further into a release position shown, does the magnetic force become so large that the magnetic switch is closed once again and then remains closed. However, this prior art assembly is still unreliable due to the well known unpredictability and temperature sensitivity of magnetic switches and, namely, the hysteresis characteristics thereof.

In view of the foregoing, there is a demand for a fuel cap sensor assembly that reliably uses a magnetic switch. There is a particular demand for a fuel cap assembly that is reliable over a wide range of temperatures, particularly low temperatures. Moreover, there is a demand for a fuel cap sensor to employ a cost effective reed switch and magnet configuration and still be accurate and reliable. There is a demand for a fuel cap assembly that accurately senses a tightened installed fuel cap. Also, there is a demand for a fuel cap assembly that eliminates a false cap closure indication when the cap is only partially closed.

### Summary of Invention

The present invention preserves the advantages of prior art fuel cap sensor assemblies which employ magnetic switches, such as reed relays. In addition, it provides new advantages not found in currently available assemblies and overcomes many disadvantages of such currently available assemblies.

The invention is generally directed to the novel and unique active sensor assembly and method which has particular application in effectively monitoring the closure status of a fuel cap for a vehicle. The active sensor assembly for fuel caps of the present invention enables the efficient, cost effective and reliable monitoring of the closure of fuel caps while eliminating the effects of temperature.

The present invention addresses the foregoing problems associated with the prior art while providing a wide degree of operating margin. The active fuel cap sensor assembly monitors the position of a fuel cap relative to a tank connection pipe. The sensor assembly communicates with the vehicle to indicate whether or not the fuel cap is fully and safely installed to the neck of the fuel tank pipe. The present invention has the capability of distinguishing a partially installed cap which has the appearance of being fully installed from a cap which is fully installed with completely tightened safety seal about the neck of the tank pipe.

The sensor assembly of the present invention may be easily incorporated in many different types of safety fuel cap designs which include a ratchet torque limiter configuration for controlling the tightening of the fuel cap to the tank connection pipe. A magnet is connected to the fuel cap and a magnetic switch, such as a reed switch, is connected to the tank connection pipe or proximal thereto. A locked fuel cap condition is indicated by the sensing of an abrupt change in magnetic field strength of the magnet caused by an abrupt physical movement thereof. When the fuel cap ratchet snaps over the ratchet cam therein, a current pulse is induced in a pickup coil. This current pulse is sensed and a logic level high voltage is produced corresponding to a tightened fuel cap condition. A dashboard lamp is then extinguished indicated that the fuel cap is safely and securely tightened. A method of sensing, determining and indicating the tightened condition of a safety fuel cap is also provided by the present invention.

It is therefore an object of the present invention to provide a fuel cap sensor assembly that is compact and can be easily incorporated into existing safety fuel cap designs.

It is an object of the present invention to provide a fuel cap sensor assembly that operates independent of temperature.

It is a further object of the present invention to provide a fuel cap sensor assembly that accurately indicates an installed and tightened fuel cap condition.

Another object of the present invention is to provide a fuel cap sensor assembly that overcomes the disadvantages of prior art sensor assemblies.

It is a further object of the present invention to provide a fuel cap sensor assembly that is expensive to manufacture.

### Brief Description of Drawings

The novel features which are characteristic of the present invention are set forth in the appended claims. However, the invention"s preferred embodiments, together with further objects and attendant advantages, will be best understood by reference to the following detailed description taken in connection with the accompanying drawings in which:

Fig. 1 is a cross-sectional view of a locking fuel cap sensor assembly in communication with a neck of a fuel tank connection pipe in accordance with the present invention;

Fig. 2 is cross-sectional view of the locking fuel cap sensor assembly of Fig. 1 after the limiting torque of a ratchet torque limiter has been exceeded; and

Fig. 3 is a schematic view of the circuit employed in the active fuel cap sensor assembly of the present invention.

### Detailed Description

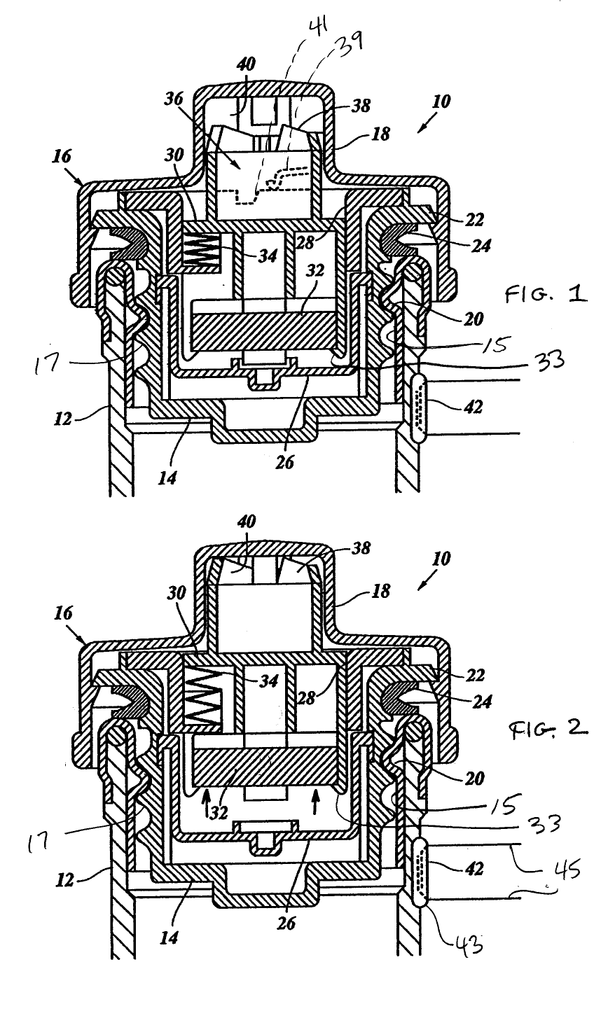

Turning first to Fig. 1, a locking fuel cap 10 is screwed onto a connection pipe 12 of a fuel tank of a vehicle (now shown). The locking fuel cap 10 has a screw-in plug 14 and a cap 16, which is connected rotatably with the screw-in plug 14 and forms a handle 18. In the opening 15 of the tank connection pipe 12, a threaded insert 20 is fastened, which has engaged the external thread 17 of the screw-in plug 14. Fig. 1 shows the locking fuel cap 10 in the closed position, in which a flange 22 of the screw-in plug, over a seal 24, is in sealing contact with the edge of the threaded insert 20.

In the interior of the screw-in plug 14, a pot-shaped inner part 26 and, further to the outside, that is, further towards the top in Fig. 1, a guiding bush 28 is disposed, in which a magnet carrier 30 is movably guided in a axial direction. A magnet 32, such as a permanent magnet, is held with holding claws 33 at the magnet carrier 30 and lies within the pot-shaped inner part 26. The guiding bush 28 at the same time forms an abutment for the springs 34, which bias the magnet carrier 30 and the magnet 32 thereon in an upward direction as shown in the resting condition shown in Fig. 1.

A known torque limiter, generally referred to as 36, is effectively disposed between the cap 16 and the screw-in plug 14. When the locking fuel cap 16 is screwed onto the tank connection pipe 12, the rotational movement of the cap 16 is transferred by this torque limiter 36 to the screw-in plug 14 until a specified limiting torque is attained. This limiting torque is selected so that the screw-in plug 14 is then screwed firmly into the threaded insert 20 and closes off the tank connection pipe 12 tightly. The torque limiter 36 is indicated in Fig. 1 merely by broken lines and is formed by springs 39, which are held at the cap 16 and engage a ring of notches 41 surrounding the guiding bush 28. In the state shown in Fig. 1, the limiting torque has just been exceeded, so that a given spring 39 has been displaced from an associated notch 41.

At its upper end protruding into the handle 18, the magnet carrier 30 has a ring of cams 38, which are skewed in the peripheral direction and interact with the releasing members 40, formed in the handle 18. When the limiting torque of the torque limiter 36 is exceeded, the cap 16 turns relative to the screw-in plug 14 and, with that, also relative to the magnet carrier 30. The releasing members 40 therefore slide on the skewed cams 38 and force the magnet carrier 30 downward, against the force of the springs 34, into the release position shown in Fig. 1.

Unlike the prior art, the present invention does not rely on the hysteresis properties of a magnetic switch to maintain closed condition or the proximity of the magnet 32 to the switch 42.

Any type of magnetic switch 42 can be employed with the present invention. Reed switches are well suited as the magnetic switch 42 of the present invention. Known reed switches include a glass envelope 43, with inert fuel or vacuum therein, as well as two signal leads 45 emanating from opposing ends of the reed switch 42. The construction of a reed switch is so well known in the art, the details thereof need not be discussed.

For the present invention, a Form "A" normally open reed switch 42 is preferred because of its low cost and its better reliability over than other types of magnetic switches, such as Form "C" reed switches. Furthermore, a Form "A" switch is ideal for the assembly 10 of the present invention because it is only used to detect the overall general position of the cap 16 thus allowing a wider and less critical switch operating sensitivity to be employed as compared to a passive sensor design. It should be understood that various other configurations of magnetic switches 42 may be employed and still be within the scope of the present invention.

The present invention monitors the position of a fuel cap 16 relative to a tank connection pipe 12 by sensing the movement of the magnet 32 relative to the magnetic switch 42, namely the abrupt movement of the magnet carrier 30 due to the forces of spring 34 when the releasing members 40 clear the ring of cams 38. This abrupt physical movement of the magnet 32 creates a corresponding abrupt change in magnetic field strength of the magnet 32 relative to a coil 50 as representationally, as will be described in connection with Fig. 3 below. When this abrupt movement occurs, a current pulse is induced in the pickup coil 50. This current pulse is sensed and a logic level high voltage is produced corresponding to a tightened fuel cap condition. A dashboard lamp (not shown) is then extinguished indicated that the fuel cap 16 is safely and securely tightened.

There are three different possible states that the cap 16 can be in which would require an accurate sensing and corresponding indication on the dashboard of a vehicle, for example. The fuel cap 16 may be 1) completely off, 2) partially installed and not tightened or 3) completely installed and fully tightened. The aforementioned current pulse sensing due to an abrupt magnetic field strength change is carried out by the circuit, generally referred to as 52 in Fig. 3, of the present invention.

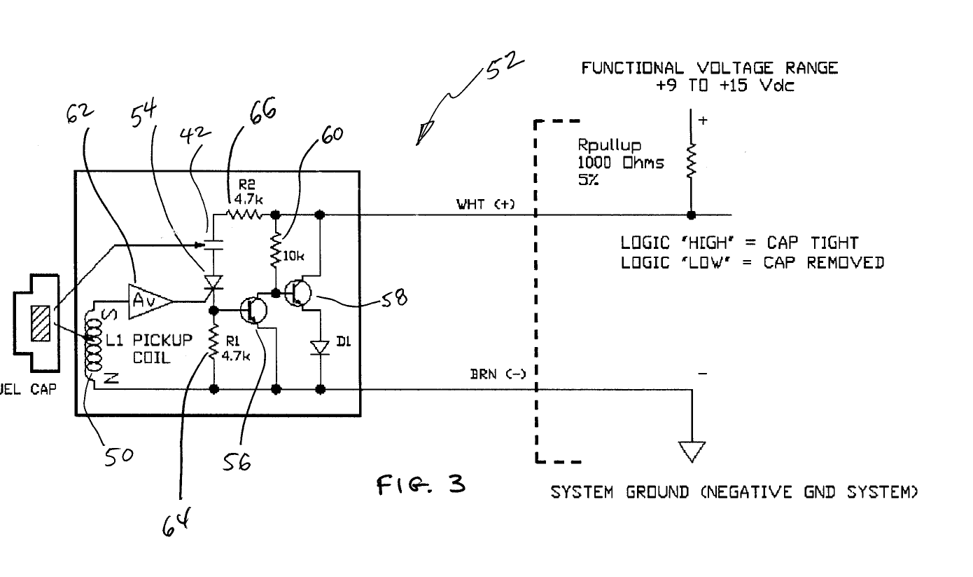

Unlike the previous passive designs of the prior art, the reed switch 42 is not positioned within a sensor coil. In accordance with the present invention, the coil 50 is used as a magnetic field pickup that detects the abrupt change of the field strength of magnet 32 during the cam snap action into the resting position shown in Fig. 2. Furthermore, a ferrous core is used to maximize the current pulse output for better detection. The coil 50 is placed proximal to the reed switch 42 for accurate sensing.

Turning first to the condition of the fuel cap 16 being completely removed from the connection pipe 12, reed switch 42 is in an open condition. With switch 42 open, the necessary hold current for silicon controller rectifier 54 (hereinafter "SCR") is removed. This results in a base voltage of 0 VDC at transistor 56, effectively turning off transistor 56 (CE open). With transistor 54 in an off state transistor 58 is biased on by pull-up resistor 60. With transistor 58 on, the sensor output voltage reduces to approximately 1.2 Vdc (transistor 56 Vce + D1 Vf) therefore supplying a logic level low. The appropriate dash lamp is then illuminated to indicate that the cap 16 is not connected to the fuel tank connection pipe 12 representing an unsafe condition.

Next, the cap 16 is screwed into the connection pipe 12 for the fuel tank. The reed switch 42 closes within one full turn prior to engagement of the o-ring seal 24 to the neck of the connection pipe 12. Unlike the previous passive design of the prior art, the reed switch 42 does not have immediate control of the dash lamp status. Closure of the reed switch 42 contacts is used as an enable function of the cap snap detection latch, otherwise known as SCR 54. Thus, the current path through SCR 54 is established thus allowing it to "fire"when triggered via the gate. This partial installation still represents an untightened and unsafe cap condition because the ratcheting of the torque limiter 36 has not yet been employed.

The cap 16 must then be further tightened using the torque limiter 36. Further threading of the cap 16 employs the torque limiter 36 whereby the releasing members 40 ride over the cams 38 to cause the magnet carrier 30 and magnet 32 thereon to abruptly move upwardly. As the magnet 32 snaps back rapidly up into its resting position as shown in Fig. 2, a current pulse is induced in the pickup coil 50, as seen in Fig. 3. A voltage amplifier Aᵥ, referenced as 62, boosts the current pulse, providing a voltage pulse of sufficient amplitude to turn on SCR 54. The trigger pulse amplitude is only sufficient during abrupt movement of cap magnet 32 as the cap ratchet snaps over the cams 38. The rapid reduction of magnetic field strength at the coil 50 generates a voltage pulse amplitude of 50 to 100 mV. This pulse amplitude is far higher than any voltage noise expected in the vehicle"s electrical system, and can therefore be unambiguously detected by appropriate circuitry.

The slower and more difficult to detect movement of magnet 32 resulting from the cam ramp-up of the torque limiter 36 does not induce enough voltage to trigger the SCR 54 because the amplitude of the generated voltage is proportional to the rate of change of the magnetic field strength with time. This fact results in a major design improvement as the sensor responds and reports a tight cap 16 only when the cap 16 has been fully snapped into position only after successful employment of the torque limiter 36.

SCR 54 remains triggered on to a conducting state, thereby being latched ON, until the current flow falls below the holding current threshold which occurs when the cap 16 is removed. This condition may only occur when the cap 16 is removed. With SCR 54 conducting, transistor 56 is biased ON via voltage divider, referred to as resistors 64 and 66. A transistor 56 ON condition biases transistor 58 OFF which increases the sensor output voltage from 1.2 Vdc to 11 Vdc (typical). The sensor output voltage now produces a logic-level high and subsequently the dashboard warning lamp is extinguished thereby indicating that the fuel cap 16 is fully and tightly installed.

It should be understood that the fuel cap configuration 10 discussed in detail herein is provided only as an example. Many different types of fuel caps 16 with different types of torque limiting constructions 36 can be employed in the present invention. Also various types of magnetic switches 42 can be employed includes reed switches other than those of the Form "A" type. As can be understood, such different switches 42 can be accommodated by appropriate modification of the control circuitry 52 of Fig. 3. Moreover, the location of the magnet 32 and the switch 42 can be modified to suit the particular cap construction at hand.

It would be appreciated by those skilled in the art that various changes and modifications can be made to the illustrated embodiments without departing from the spirit of the present invention. All such modifications and changes are intended to be covered by the appended claims.

Claims

1. An apparatus for monitoring the closed position of a fuel cap relative to a tank connection pipe, comprising:
a fuel cap;
a tank connection pipe having a wall;
ratchet means connected to the fuel cap for controlling tightening of the fuel cap to the tank connection pipe;
a magnet connected to the fuel cap;
a magnetic switch connected to the tank connection pipe; and
means for sensing abrupt movement of the magnet relative to the magnetic switch, indicating a locked fuel cap condition, by sensing an abrupt change in magnetic field strength of the magnet.

2. The apparatus of Claim 1, wherein the magnetic switch is a reed switch.

3. The apparatus of Claim 2, wherein the reed switch is a form A, normally open, reed switch.

4. The apparatus of Claim 1, wherein the magnetic switch is embedded within the wall of the tank connection pipe.

5. The apparatus of Claim 1, wherein the fuel cap includes male threading engageable with female threading on an interior surface of the wall of the tank connection pipe.

6. A method for monitoring the closed position of a fuel cap relative to a tank connection pipe, comprising the steps of:
providing a fuel cap;
providing a tank connection pipe;
providing a magnet connected to the fuel cap;
providing a magnetic switch connected to the tank connection pipe; and
sensing abrupt movement of the magnet relative to the magnetic switch, indicating a tightened fuel cap condition, by sensing an abrupt change in magnetic field strength of the magnet.

7. The method of Claim 6, wherein the step of sensing abrupt movement further comprises the steps of:
providing a circuit with a pickup coil and an output;
snapping the fuel cap into a rest condition;
inducing a current pulse in the pickup coil;
sensing the current pulse;
producing a logic level high voltage at the output; and
displaying an indication of a tightened fuel cap condition.
